(19) United States
(12) Patent Application Publication
(10) Pub. No.: US 2014/0149767 A1
(43) Pub. Date: May 29, 2014

(54) MEMORY CONTROLLER AND OPERATING METHOD OF MEMORY CONTROLLER

(71) Applicant: SAMSUNG ELECTRONICS CO., LTD., Suwon-si (KR)

(72) Inventors: Eunchan KIM, Suwon-si (KR); Bumseok YU, Suwon-si (KR); Hojun SHIM, Yongin-si (KR)

(73) Assignee: SAMSUNG ELECTRONICS CO., LTD., Suwon-si (KR)

(21) Appl. No.: 14/088,602

(22) Filed: Nov. 25, 2013

(30) Foreign Application Priority Data
Nov. 27, 2012 (KR) 10-2012-0135382

(51) Int. Cl. G06F 1/32

(52) U.S. Cl. CPC G06F 1/3275
USPC 713/320

(57) ABSTRACT

A memory controller and an operating method of a memory controller are provided. The operating method includes detecting that a bus of an external host connected with the memory controller enters a first power saving mode; entering a second power saving mode of the memory controller according to a result of the detecting; detecting a wake-up process of the bus of the external host; and waking up the memory controller while the bus of the external host executes the wake-up process. The waking up of the memory controller is ended before the wake-up process of the bus of the external host is completed.

### CROSS-REFERENCE TO RELATED APPLICATIONS

This application claims priority from Korean Patent Application No. 10-2012-0135382 filed Nov. 27, 2012, in the Korean Intellectual Property Office, the entire contents of which are hereby incorporated by reference.

### BACKGROUND

1. Field

Methods, devices, and articles of manufacture consistent with this disclosure relate to a semiconductor memory, and more particularly, to a memory controller and an operating method of the memory controller.

2. Description of Related Art

A semiconductor memory device is a memory device which is fabricated using semiconductors such as silicon (Si), germanium (Ge), gallium arsenide (GaAs), indium phosphide (InP), and so on. Semiconductor memory devices are classified into volatile memory devices and nonvolatile memory devices.

The volatile memory devices may lose stored contents at power-off. Examples of volatile memory devices include a static RAM (SRAM), a dynamic RAM (DRAM), a synchronous DRAM (SDRAM), and the like. The nonvolatile memory devices may retain stored contents even at power-off. Examples of nonvolatile memory devices include a read only memory (ROM), a programmable ROM (PROM), an electrically programmable ROM (EPROM), an electrically erasable and programmable ROM (EEPROM), a flash memory device, a phase-change RAM (PRAM), a magnetic RAM (MRAM), a resistive RAM (RRAM), a ferroelectric RAM (FRAM), and so on.

A semiconductor memory device may perform write, read and erase operations according to a control of a memory controller. The memory controller may control the semiconductor memory device according to an instruction of a host. The memory controller may provide an interface between the host and the semiconductor memory device.

As mobile devices become increasingly popular, research on improvement of the mobile device is being performed. The performance of the mobile device may be increased by reducing power consumption of the mobile device.

### SUMMARY

According to an aspect of an exemplary embodiment, there is provided an operating method of a memory controller which is connected with an external host, the operating method comprising detecting that a bus of the external host enters a first power saving mode; entering a second power saving mode of the memory controller according to a result of the detecting; detecting a wake-up process of the bus of the external host; and waking up the memory controller while the bus of the external host executes the wake-up process, wherein the waking up is ended before the wake-up process of the bus of the external host is completed.

The detecting that the bus of the external host enters the first power saving mode may comprise detecting a power saving process of the bus of the external host.

The detecting that the bus of the external host enters the first power saving mode may comprise detecting that the bus of the external host is in the first power saving mode.

The entering the second power saving mode and the waking up may be executed by an Advanced Host Controller Interface (AHCI) included in the memory controller.

The entering the second power saving mode and the waking up may be executed by an interface included in the memory controller and recognized as storage by the external host.

The entering the second power saving mode may comprise reading a register of the interface; backing up data read from the register; and turning off power of the interface.

The waking up may comprise supplying power to the interface; and storing the backed-up data in the register of the interface.

When the bus of the external host enters the first power saving mode, the interface may enter the second power saving mode although a power saving mode instruction is not transferred from the external host.

The bus of the external host may operate according to a Peripheral Component Interconnect express (PCIe) interface.

According to an aspect of another exemplary embodiment, there is provided a memory controller which comprises a first interface configured to communicate with a host; and a second interface configured to communicate with the first interface and a memory and to be recognized as storage by the host, wherein in response to detecting that a bus of the host enters a first power saving mode, the second interface enters a second power saving mode, and wherein in response to detecting that the bus of the host executes a wake-up process, the second interface wakes up before the wake-up process is completed.

The second interface may comprise a register configured to exchange information with the first interface; and a state machine configured to operate according to information stored in the register. The state machine may control the register and the state machine to enter the second power saving mode.

The memory controller may further comprise a bus configured to interconnect the state machine, the register and the first interface and to provide a channel by which the state machine accesses the register and by which the state machine accesses the register through the first interface.

When entering the second power saving mode, the state machine may directly read directly accessible data of data stored in the register to back up the directly read data and may read data readable only by the host of the data stored in the register through the bus and the first interface to back up the read data.

When waking up, the state machine may directly write directly writable data of the backed-up data in the register and may write data writable only by the host of the backup data in the register through the first interface.

The memory controller may comprise a solid state drive together with the memory which is a nonvolatile memory.

According to an aspect of another exemplary embodiment, there is provided a memory controller comprising a first interface configured to communicate with a bus of a host using a first interface type; and a second interface configured to communicate with the first interface and with a memory, the second interface being of a second interface type different than the first interface type and being recognized as storage by the host, wherein in response to detecting that the bus of the host is performing a power saving process to enter a power saving mode, the second interface starts entering a power saving mode of the second interface before the host enters the power saving mode.

### BRIEF DESCRIPTION OF THE DRAWINGS

The above and other aspects will become apparent from the following description with reference to the following drawings, wherein like reference numerals refer to like parts throughout the various figures unless otherwise specified, and wherein:

FIG. 1 is a block diagram schematically illustrating a computing system according to an exemplary embodiment;

FIG. 2 is a flowchart schematically illustrating an operating method of the memory controller of FIG. 1;

FIG. 3 is a block diagram schematically illustrating a memory controller according to an exemplary embodiment;

FIG. 4 is a block diagram schematically illustrating a first interface and a storage engine of the memory controller of FIG. 3;

FIG. 5 is a flowchart schematically illustrating a method in which a state machine (SM) controls a storage engine with a power saving mode according to an exemplary embodiment;

FIG. 6 is a flowchart schematically illustrating a method in which a state machine controls a storage engine with an active mode according to an exemplary embodiment;

FIG. 7 is a timing diagram schematically illustrating an example in which a storage engine enters a power saving mode or an active mode according to a state of a host bus, according to an exemplary embodiment; and

FIG. 8 is a block diagram schematically illustrating storage according to another exemplary embodiment.

### DETAILED DESCRIPTION

Exemplary embodiments will be described in detail with reference to the accompanying drawings. The inventive concept, however, may be embodied in various different forms, and should not be construed as being limited only to the illustrated exemplary embodiments. Rather, these exemplary embodiments are provided as examples so that this disclosure will be thorough and complete, and will fully convey the concept of the inventive concept to those skilled in the art. Accordingly, known processes, elements, and techniques are not described with respect to some of the exemplary embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular exemplary embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

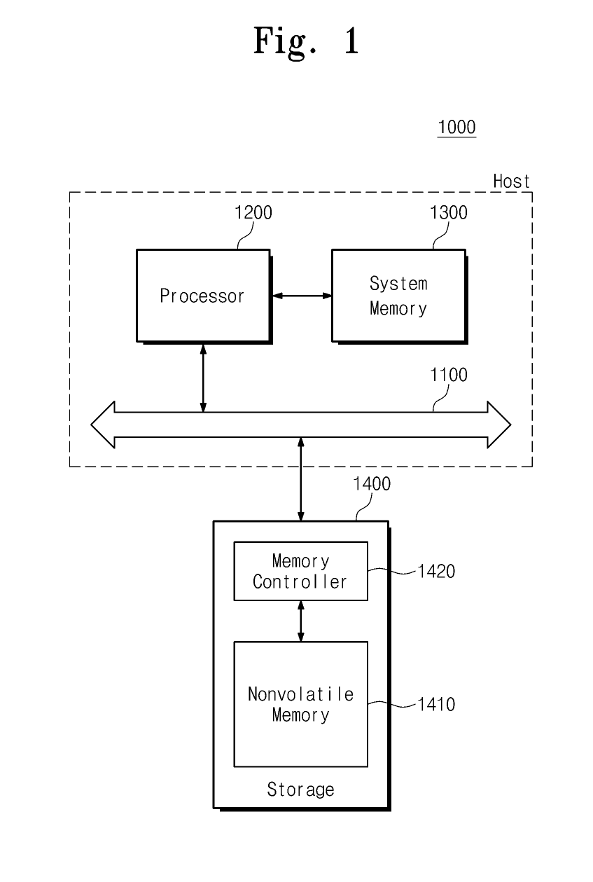

FIG. 1 is a block diagram schematically illustrating a computing system 1000 according to an exemplary embodiment. Referring to FIG. 1, a computing system 1000 may include a bus 1100, a processor 1200, a system memory 1300, and a storage 1400.

The bus 1100 may provide a channel between constituent elements of the computing system 1000. For example, the bus 1100 may provide a channel between the processor 1200 and the storage 1400. The bus 1100 may operate based on a standard interface of the computing system 1000. For example, the bus 1100 may operate based on a Peripheral Component Interconnect express (PCIe) interface. However, the bus 1100 is not limited to the PCIe interface. The bus 1100 may be applied to devices which operate based on various interfaces providing channels between various constituent elements.

The processor 1200 may be configured to control constituent elements of the computing system 1000. For example, the processor 1200 may access the system memory 1300 and control the storage 1400 through the bus 1100. The processor 1200 may control the storage 1400 based on the PCIe interface. The processor 1200 may include a general purpose processor or an application processor. The processor 1200 may be one or more hardware microprocessors.

The system memory 1300 may be configured to communicate with the processor 1200. The system memory 1300 may include a volatile memory such as an SRAM, a DRAM, an SDRAM, or the like or a nonvolatile memory such as a phase change RAM (PRAM), a magnetic RAM (MRAM), a resistive RAM (RRAM), a ferroelectric RAM (FRAM), or the like.

The storage 1400 may be configured to communicate with the processor 1200 through the bus 1100. For example, the storage 1400 may communicate with the processor 1200 and the system memory 1300 based on the PCIe interface. The storage 1400 may be used to retain data for a long time. The storage 1400 may include a nonvolatile memory 1410 and a memory controller 1420.

The nonvolatile memory 1410 may include at least one nonvolatile memory. Examples of nonvolatile memories may be a flash memory, a phase change RAM (PRAM), a magnetic RAM (MRAM), a resistive RAM (RRAM), a ferroelectric RAM (FRAM), and the like.

The memory controller 1420 may communicate with the processor 1200 and the system memory 1300 through the bus 1100 and control the nonvolatile memory 1410. For example, the memory controller 1420 may communicate with the processor 1200 and the system memory 1300 through the PCIe interface.

The memory controller 1420 may include an interface which is recognized as storage by the bus 1100 or the processor 1200. For example, if the storage 1400 is connected with the bus 1100, the memory controller 1420 may perform predetermined communication with the processor 1200 and/or the bus 1100. According to a result of the predetermined communication, the storage 1400 may be recognized as storage by the bus 1100 and/or the processor 1200. That is, the memory controller 1420 may communicate with the processor 1200 and the system memory 1300 based on a standard interface (e.g., PCIe) of the computing system 1000, and may include an interface which is recognized as storage by the bus 1100 or the processor 1200.

The bus 1100, the processor 1200 and the system memory 1300 may constitute a host of the storage 1400.

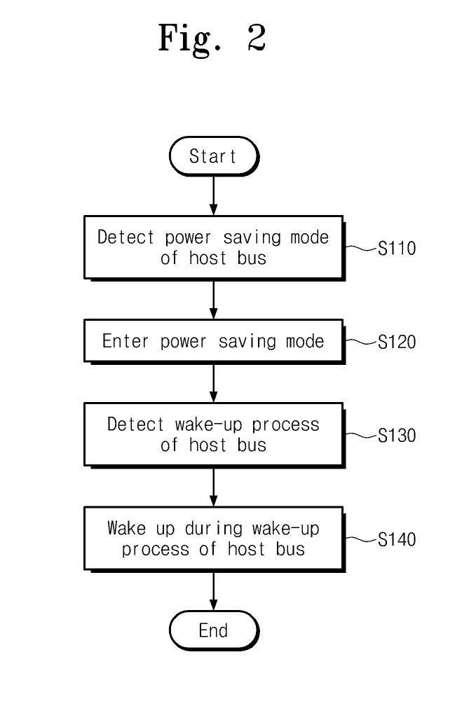

FIG. 2 is a flowchart schematically illustrating an operating method of a memory controller 1420 of FIG. 1. In FIG. 2, there is illustrated an operation of an interface of a memory controller 1420 which communicates with a processor 1200 through a bus 1100 according to a standard interface (e.g., PCIe) of a computing system 1000 and is recognized as storage by the processor 1200 or the bus 1100.

Referring to FIGS. 1 and 2, in operation S110, the memory controller 1420 may detect whether the bus 1100 of a host enters a power saving mode. For example, the memory controller 1420 may detect that the bus 1100 of a host executes a power saving process for entering the power saving mode. The memory controller 1420 can detect whether the bus 1100 of a host is in a power saving mode.

In example embodiments, the bus 1100 of the host may enter the power saving mode according to a control of the processor 1200, according to a predetermined schedule, or when data is not transferred. The memory controller 1420 may detect that the bus 1100 of the host has entered the power saving mode when the bus 1100 of the host does not perform data transfer.

In operation S120, the memory controller 1420 may enter the power saving mode. For example, the memory controller 1420 may enter the power saving mode by detecting that the bus 1100 of the host has entered the power saving mode.

In operation S130, the memory controller 1420 may detect that the bus 1100 of the host performs a wake-up process. For example, the memory controller 1420 may detect that the bus 1100 of the host performs the wake-up process or a wake-up call generated to perform the wake-up process.

In operation S140, while the bus 1100 of the host performs the wake-up process, the memory controller 1420 may wake up. For example, before the bus 1100 of the host wakes up and enters an active mode, the memory controller 1420 may complete a wake-up operation and enter the active mode.

The memory controller 1420 which communicates with a standard interface (e.g., PCIe) of the computing system 1000 and is recognized as storage by a standard interface of the processor 1200 or the computing system 1000, without installation of a separate driver, may start to enter a power saving mode after the bus 1100 starts to enter the power saving mode and may wake up to enter an active mode before the bus 1100 of the host wakes up to enter the active mode. That is, although a separate power saving instruction is not received from the bus 1100 of the host and/or the processor 1200, the memory controller 1420 may enter the power saving mode without hindering communications between the bus 1100 of the host and the memory controller 1420. Thus, it is possible to reduce power consumption of the memory controller 1420 and storage 1400 including the memory controller 1420.

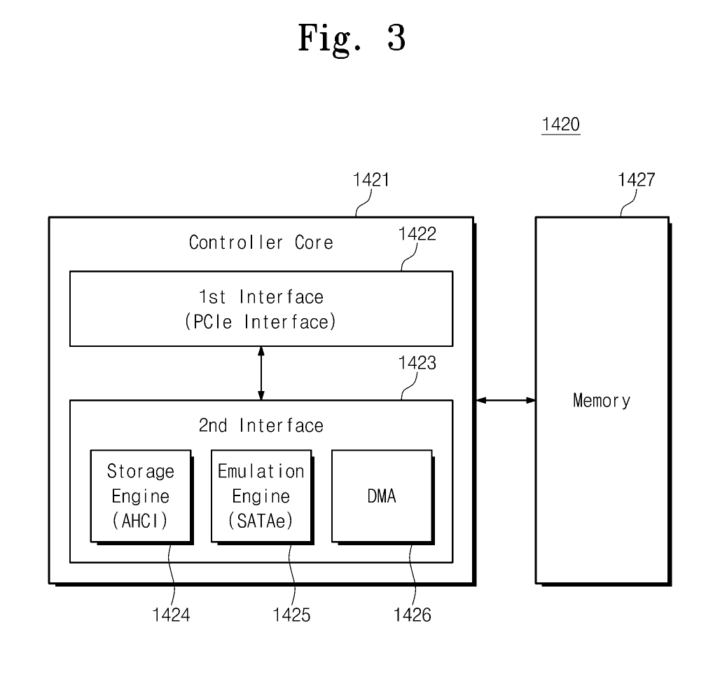

FIG. 3 is a block diagram schematically illustrating a memory controller 1420 according to an exemplary embodiment. Referring to FIGS. 1 and 3, a memory controller 1420 may include a controller core 1421 and a memory 1427. The controller core 1421 may use the memory 1427 as a working memory and/or as a buffer memory. The memory 1427 may include a volatile memory such as an SRAM, a DRAM, an SDRAM, or the like, and/or a nonvolatile memory such as a phase change RAM (PRAM), a magnetic RAM (MRAM), a resistive RAM (RRAM), a ferroelectric RAM (FRAM), or the like.

The controller core 1421 may include a first interface 1422 and a second interface 1423.

The first interface 1422 may communicate with the bus 1100 based on a standard interface of the computing system 1000. For example, the first interface 1422 may include a PCIe interface as a standard interface of the bus 1100 in the computing system 1000.

The second interface 1423 may communicate with the bus 1100 in the computing system 1000 through the first interface 1422, and may communicate with the nonvolatile memory 1410. The second interface 1423 may include an interface which is recognized as storage by the processor 1200 and/or the bus 1100.

The second interface 1423 may include a storage engine 1424, an emulation engine 1425, and a Direct Memory Access (DMA) 1426.

The storage engine 1424 may include an interface which is recognized as storage by the processor 1200 and/or the bus 1100. For example, the storage engine 1424 may include an Advanced Host Control Interface (AHCI). However, the inventive concept is not limited thereto. The storage engine 1424 may include various interfaces recognized as storage by a standard interface of the processor 1200, the bus 1100, and/or the computing system 1000, without installation of a separate driver.

The emulation engine 1425 may emulate a storage interface which is configured for the storage engine 1424 to control. For example, the AHCI may be configured to control a Serial AT Attachment (SATA) interface. When the storage engine 1424 includes the AHCI, the emulation engine 1425 may emulate a SATA or SATA express (SATAe) interface. The emulation engine 1425 may be provided for a normal operation.

For example, the AHCI may be configured to communicate with an upper constituent element (e.g., the processor 1200 and/or the bus 1100 of the computing system 1000) through a PCIe interface and to communicate with a lower constituent element (e.g., storage 1400) through the SATA or, SATAe interface. The AHCI may operate normally when both an upper channel and a lower channel operate according to the specification. Thus, the emulation engine 1425 may be provided to secure a normal operation of the storage engine 1424.

The DMA 1426 may support access of the controller core 1421 to the memory 1427.

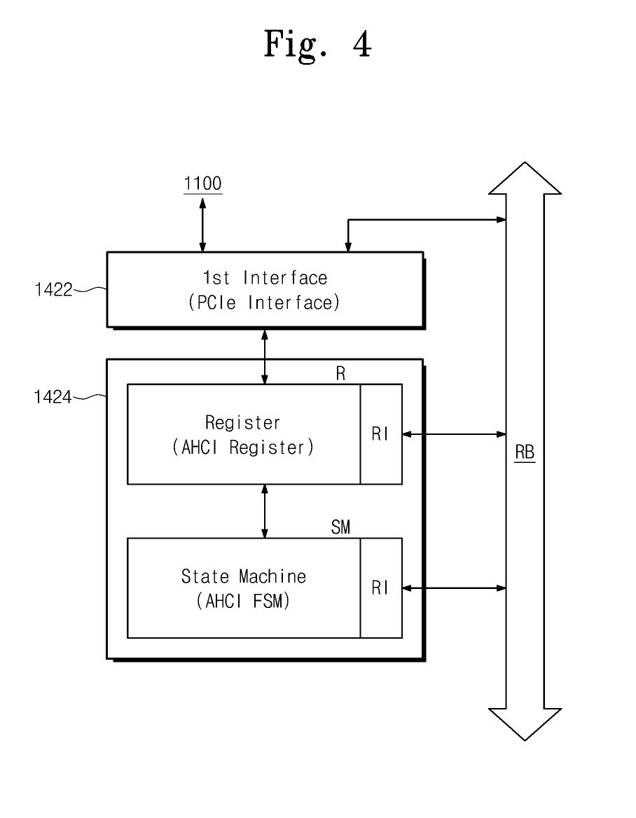

FIG. 4 is a block diagram schematically illustrating a first interface 1422 and a storage engine 1424 of FIG. 3. Referring to FIGS. 1, 3, and 4, a storage engine 1424 may include a register R and a state machine SM. The register R may include a plurality of registers, the plurality of registers may be, for example, defined by the AHCI specification.

The register R may exchange information with a host through the first interface 1422. For example, the register R may store a command received from the host through the first interface 1422. The register R may store information on an execution result of a command executed by the storage engine 1424. The host and the storage engine 1424 may exchange information by setting bits of the register R and reading the set bits.

The state machine SM may control the nonvolatile memory 1410 according to information stored in the register R. The state machine SM may store a control result of the nonvolatile memory 1410 in the register R. The state machine SM may control the storage engine 1424 according to a power saving mode or an active mode. In exemplary embodiments, the state machine SM may be an AHCI Finite State Machine (FSM).

Each of the register R and the state machine SM may include a register interface RI. The register interface RI may be connected with a register bus RB. The register bus RB may provide a channel between the register R, the state machine SM and the first interface 1422. In exemplary embodiments, the register bus RB may operate based on a standard interface (e.g., PCIe) of the computing system 1000.

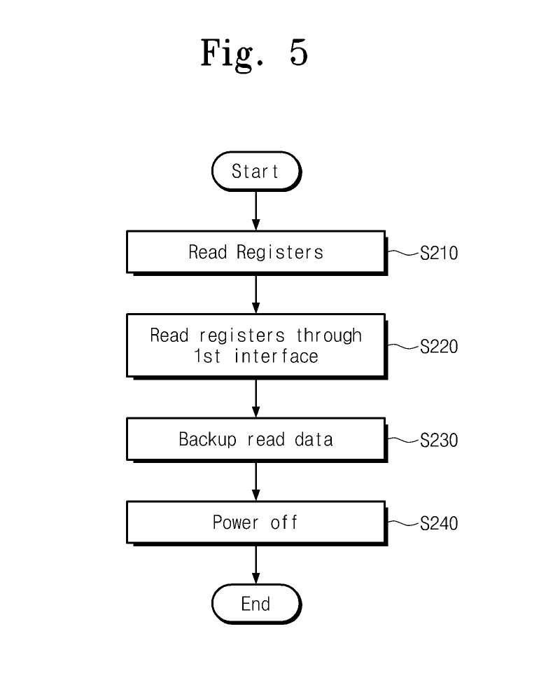

FIG. 5 is a flowchart schematically illustrating a method in which a state machine SM controls a storage engine 1424 according to a power saving mode, according to an exemplary embodiment.

Referring to FIGS. 4 and 5, in operation S210, a state machine SM may read a register. For example, the state machine SM may directly read data, directly accessible, from among data stored in the register R. The state machine SM can directly read the directly accessible data from the register R through the register interface RI and the register bus RB.

In exemplary embodiments, the state machine SM may read data stored in GHC, IS, CCC_CTL, CCC_PORTS, PxCLB, PxCLBU, PxFB, PxFBU, PxIS, PxIE, PxCMD, PxTFD, PxSIG, PxSCTL, and PxSERR registers of registers defined by the AHCI specification.

In operation S220, the state machine SM may read data stored in the register R through the first interface 1422. For example, a part of data of the register R may be written and/or read only by a host. To read such data, the state machine SM may be connected with the first interface 1422 through the register interface RI and the register bus RB, and may read data stored in the register R through the first interface 1422.

In exemplary embodiments, the state machine SM may read pUpdateSig, pBsy, pDrq, pSlotLoc, hCccComplete, and hCccTimer registers of registers defined by the AHCI specification through the first interface 1422.

In operation S230, the state machine SM may back up the read data. In exemplary embodiments, the state machine SM may output the read data to an external device. The output data may be backed up by the memory controller 1420.

In operation S240, the state machine SM may perform power-off. The state machine SM may control such that the register R is powered off and the state machine SM is powered off. The state machine SM may be powered of by the memory controller 1420 according to a request of the state machine SM.

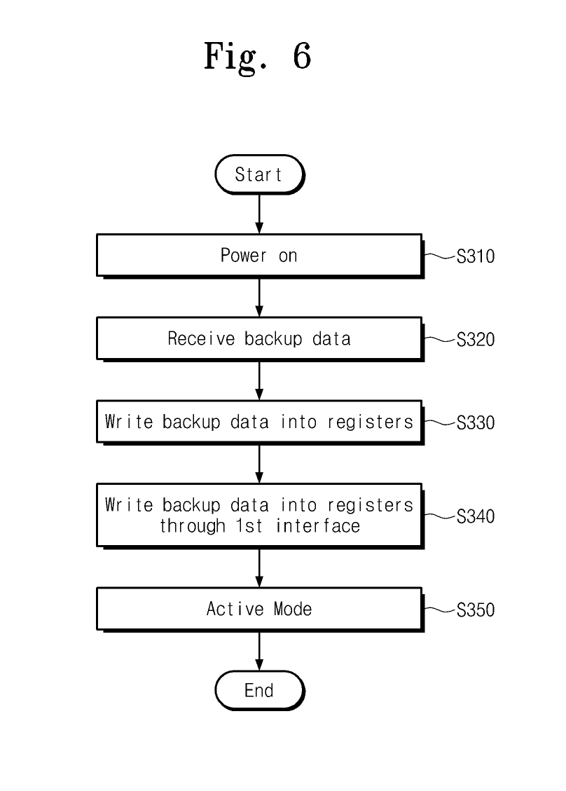

FIG. 6 is a flowchart schematically illustrating a method in which a state machine SM controls a storage engine 1424 according to an active mode, according to an exemplary embodiment.

Referring to FIGS. 4 and 6, in operation S310, the state machine SM may be powered on. For example, the memory controller 1420 may detect a wake-up process of the bus 1100 of the host and power up the state machine SM, or power up the state machine SM and the register R. In exemplary embodiments, the state machine SM may decide whether the register R is powered up.

In operation S320, the state machine SM may receive backup data. For example, the state machine SM may receive data backed up at a power saving process from the memory controller 1420. Alternatively, the state machine SM may read the backed up data from the memory controller 1420.

In operation S330, the state machine SM may write the backup data in the register R. For example, the state machine SM may directly write writable data of the backup data in the register R. The state machine SM may directly write writable data in the register R through the register interface RI and the register bus RB.

In exemplary embodiments, the state machine SM may write backup data in GHC, IS, CCC_CTL, CCC_PORTS, PxCLB, PxCLBU, PxFB, PxFBU, PxIS, PxIE, PxCMD, PxTFD, PxSIG, PxSCTL, and PxSERR registers of registers defined by the AHCI specification.

In operation S340, the state machine SM may write the backup data in the register R through the first interface 1422. For example, a part of data of the register R may be written and/or read only by a host. To read such data, the state machine SM may be connected with the first interface 1422 through the register interface RI and the register bus RB, and may write the backup data at the register R through the first interface 1422.

In exemplary embodiments, the state machine SM may write the backup data in pUpdateSig, pBsy, pDrq, pSlotLoc, hCccComplete, and hCccTimer registers of registers defined by the AHCI specification through the first interface 1422.

In operation S350, the state machine SM may enter an active mode.

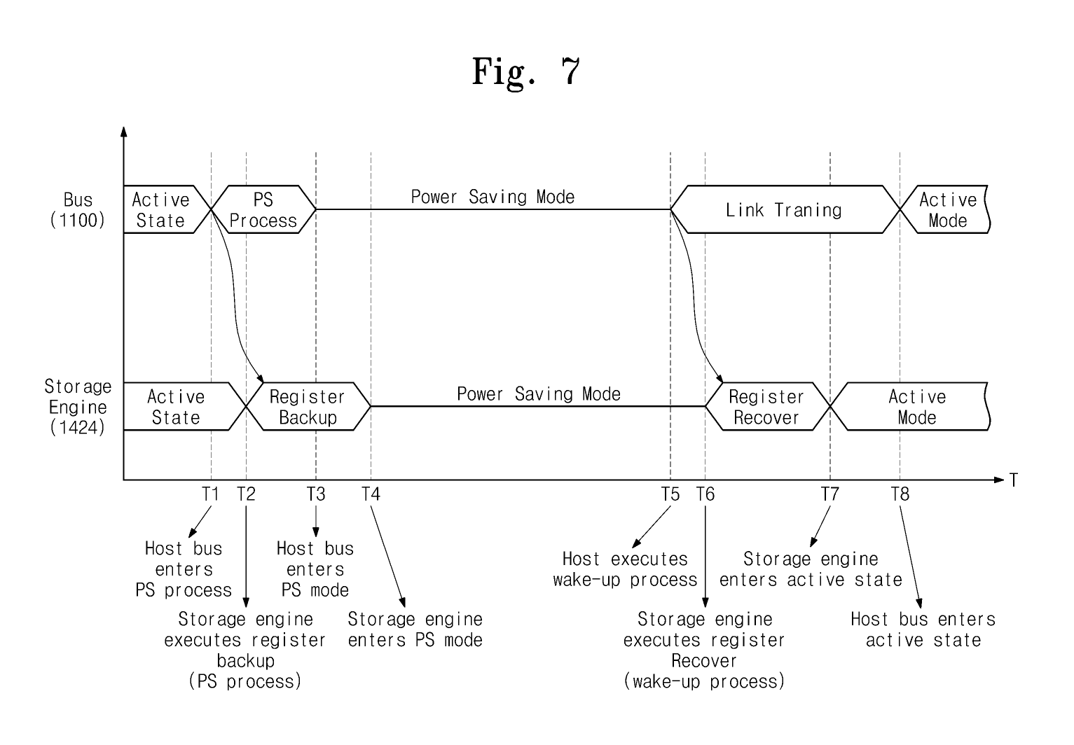

FIG. 7 is a timing diagram schematically illustrating an example in which the storage engine 1424 enters a power saving mode and returns to an active mode according to a state of the bus 1100 of the host. Referring to FIGS. 1, 3, 4, and 7, at an initial state, the bus 1100 of the host and the storage engine 1424 may be at an active state.

At T1, the bus 1100 of the host may start a power saving process (PS Process) for entering a power saving mode. The power saving process may include an operation of backing up major data.

As the host bus 1100 entering the power saving mode is detected, at T2, the storage engine 1424 may start a backup of the register R. The backup of the register R may be a power saving process of the storage engine 1424. In exemplary embodiments, as the host bus 1100 transfers a call for starting the power saving process, as the host bus 1100 performs a power saving mode, or as the host bus 1100 is at a power saving mode, the storage engine 1424 may start the backup of the register R. For a simple description, in FIG. 7, there is illustrated an example in which the storage engine 1424 starts the backup of the register R as the host bus 1100 starts the power saving mode. An execution condition and particular timing of the backup of the register R through the storage engine 1424 is not limited, as long as the storage engine 1424 starts the backup of the register R at some point during the power saving process of the bus 1100.

At T3, the host bus 1100 may complete the power saving process and enter the power saving mode.

At T4, as the backup of the register R through the storage engine 1424 is completed, the storage engine 1424 may enter the power saving mode.

At T5, the bus 1100 may start a wake-up process for entering an active mode. In exemplary embodiments, the wake-up process may include link training defined by the PCIe specification. However, the wake-up process is not limited to the link training.

As the wake-up process of the bus 1100 is detected, at T6, the storage engine 1424 may recover the register R. A recovery of the register R may be the wake-up process allowing the storage engine 1424 to enter the active mode.

At T7, as the recovery of the register R of through storage engine 1424 is completed, the storage engine 1424 may enter the active mode.

At T8, as the wake-up process of the bus 1100 is completed, the bus 1100 may enter the active mode.

As described above, a memory controller 1420 may have an interface (e.g., AHCI) which is recognized as storage by a host. Thus, the storage 1400 may operate normally through connection with the host without installation of a separate driver. Also, it is possible to use the storage or the memory controller according to an exemplary embodiment without a change of a host structure and/or interface.

The storage engine 1424 including the interface (e.g., AHCI) recognized as storage may start to enter the power saving mode after the bus 1100 starts to enter the power saving mode, and may enter the active mode before the bus 1100 enters the active mode. The power saving mode may be used without hindering communications between the bus 1100 of the host and the memory controller 1420. Also, it is possible to reduce power consumption of the memory controller 1420 and the storage 1400.

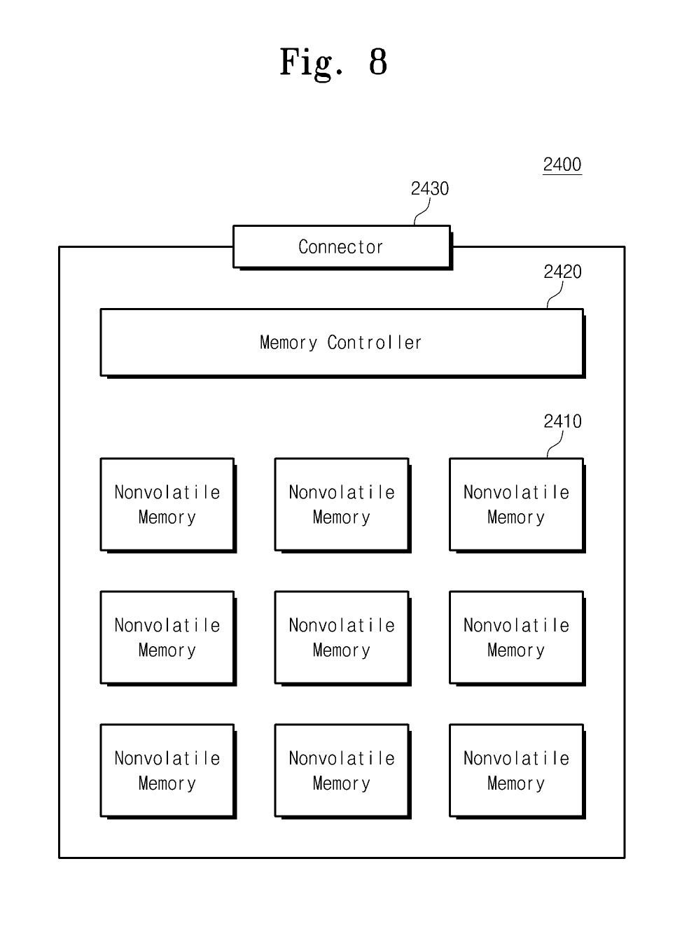

FIG. 8 is a block diagram schematically illustrating a storage according to another exemplary embodiment. Referring to FIG. 8, a storage 2400 may include a plurality of nonvolatile memories 2410, a memory controller 2420, and a connector 2430.

The memory controller 2420 may operate substantially the same as described with reference to FIGS. 2 to 7 and thus repeated description will be omitted here.

The connector 2430 may connect the storage 2400 with a host. For example, the connector 2430 may be a connector of a standard interface used by the host. For example, the connector 2430 may be a connector of a PCIe interface.

The storage 2400 may be a solid state drive (SSD). The storage 2400 may be connected with the host (e.g., a server, a main frame, etc.) which uses high-speed and mass storage.

While the inventive concept has been described with reference to exemplary embodiments, it will be apparent to those skilled in the art that various changes and modifications may be made without departing from the spirit and scope of the present inventive concept. Therefore, it should be understood that the above exemplary embodiments are not limiting, but illustrative.

What is claimed is:

1. An operating method of a memory controller which is connected with an external host, the operating method comprising:
detecting that a bus of the external host enters a first power saving mode;
entering a second power saving mode of the memory controller according to a result of the detecting;
detecting a wake-up process of the bus of the external host; and
waking up the memory controller while the bus of the external host executes the wake-up process,
wherein the waking up the memory controller is ended before the wake-up process of the bus of the external host is completed.

2. The operating method of claim 1, wherein the detecting that the bus of the external host enters the first power saving mode comprises detecting a power saving process of the bus of the external host.

3. The operating method of claim 1, wherein the detecting that the bus of the external host enters the first power saving mode comprises:
detecting that the bus of the external host is in the first power saving mode.

4. The operating method of claim 1, wherein the entering the second power saving mode and the waking up the memory controller are executed by an Advanced Host Controller Interface (AHCI) included in the memory controller.

5. The operating method of claim 1, wherein the entering the second power saving mode and the waking up the memory controller are executed by an interface included in the memory controller and recognized as storage by the external host.

6. The operating method of claim 5, wherein the entering the second power saving mode comprises:
reading a register of the interface;
backing up data read from the register; and
turning off power of the interface.

7. The operating method of claim 6, wherein the waking up the memory controller comprises:
supplying power to the interface; and
storing the backed-up data in the register of the interface.

8. The operating method of claim 5, wherein in response to the bus of the external host entering the power saving mode, the interface enters the second power saving mode although a power saving mode instruction is not transferred from the external host.

9. The operating method of claim 1, wherein the bus of the external host operates according to a Peripheral Component Interconnect express (PCIe) interface.

10. A memory controller comprising:
a first interface configured to communicate with a host; and
a second interface configured to communicate with the first interface and with a memory, the second interface being recognized as storage by the host,
wherein in response to detecting that a bus of the host enters a first power saving mode, the second interface enters a second power saving mode, and
wherein in response to detecting that the bus of the host executes a wake-up process, the second interface wakes up before the wake-up process of the host is completed.

11. The memory controller of claim 10, wherein the second interface comprises:
a register configured to provide for exchange of information with the first interface; and
a state machine configured to operate according to the information stored in the register,
wherein the state machine controls the register and the state machine to enter the second power saving mode.

12. The memory controller of claim 11, further comprising:
a bus configured to interconnect the state machine, the register and the first interface and to provide a channel by which the state machine accesses the register, and by which the state machine accesses the register through the first interface.

13. The memory controller of claim 12, wherein when entering the second power saving mode, the state machine directly reads directly accessible data of data stored in the register to back up the directly read data, and reads data readable only by the host of the data stored in the register through the bus and the first interface to back up the read data.

14. The memory controller of claim 13, wherein when waking up, the state machine directly writes directly writable data of the backed up data in the register and writes data of the back up data that is writable only by the host in the register through the first interface.

15. The memory controller of claim 10, wherein the memory controller constitutes a solid state drive together with the memory which is a nonvolatile memory.

16. A memory controller comprising:
a first interface configured to communicate with a bus of a host using a first interface type; and
a second interface configured to communicate with the first interface and with a memory, the second interface being of a second interface type different than the first interface type and being recognized as storage by the host,
wherein in response to detecting that the bus of the host is performing a power saving process to enter a power saving mode, the second interface starts entering a power saving mode of the second interface before the host enters the power saving mode.

17. The memory controller of claim 16, wherein the bus is detected as performing the power saving process without using a driver or receiving a power saving instruction message over the bus.

18. The memory controller of claim 16, wherein:
wherein in response to detecting that the bus of the host is executing a wake-up process, the second interface enters an active state before the wake-up process of the bus of the host is completed.

19. The memory controller of claim 16, wherein the memory is an external memory that is external to the memory controller.

20. The memory controller of claim 16, wherein the memory controller constitutes a solid state drive together with the memory which is a nonvolatile memory.
